(19) United States
(12) Patent Application Publication
(10) Pub. No.: US 2019/0150668 A1
(43) Pub. Date: May 23, 2019

(54) Microwavable Mixing Container

(71) Applicants: Aimee Ascher, German Valley, IL (US); Dean Meyer, German Valley, IL (US)

(72) Inventors: Aimee Ascher, German Valley, IL (US); Dean Meyer, German Valley, IL (US)

(21) Appl. No.: 16/172,028

(22) Filed: Oct. 26, 2018

Related U.S. Application Data
(60) Provisional application No. 62/707,803, filed on Nov. 20, 2017.

(51) Int. Cl. A47J 43/046; A47J 36/02; B01F 7/24; B01F 15/00

(52) U.S. Cl. CPC A47J 43/046; A47J 36/027; B01F 2215/0026; B01F 15/00538; B01F 2015/00597; B01F 7/245

(57) ABSTRACT

A microwavable container for use in a microwave oven that includes provisions to stir or mix food during microwave cooking. This mixing action is achieved by utilizing the motor of the microwave oven. Such mixing provides more even heating of food, and reduces the need to stop the microwave oven to manually stir food.

### CROSS-REFERENCE TO RELATED PATENT APPLICATIONS

This patent application claims the benefit of U.S. Provisional Patent Application No. 62/707,803, filed Nov. 20, 2017, the entire teachings and disclosure of which are incorporated herein by reference thereto.

### FIELD OF THE INVENTION

This invention generally relates to cookware and tableware, and more particularly to microwavable containers used for containing foods during microwave cooking.

### BACKGROUND OF THE INVENTION

Microwave ovens are a staple in the contemporary home. Such devices provide a plethora of conveniences for modern living. As is readily known, such devices have given rise to a variety of microwavable containers which can be used to contain foods during microwave cooking. These containers come in a variety of shapes and sizes, and are made of materials which can withstand the microwave cooking process. Some such containers are engineered well enough so that the food they contain is heated during microwave cooking, while the containers themselves remain cool to the touch. Microwavable containers thus provide a key component to the microwave cooking process.

Despite the above advantages of such microwavable containers, they are not without their own drawbacks. As one example, it is readily known that microwave cooking can oftentimes lead to uneven heating of food, particularly liquids. This problem can be exacerbated by the shape of the container containing the food. Most contemporary microwave ovens address this problem of uneven heating via a number of different approaches.

One approach is to utilize a rotatable turntable in the microwave oven. The food is placed on the turntable, or placed in a container which is then placed on the turntable, and the turntable rotates during microwave cooking in an effort to evenly heat the food and avoid any “hot spots.” Another approach is to provide a non-constant exposure to microwaves during cooking in an effort to allow the hot spots to transfer their heat energy to surrounding cooler portions of the food. Still another approach is deliberate pauses in the cooking time to allow a user to open the microwave oven and manually stir or mix the food.

As most microwave oven users can attest, despite the above approaches, uneven heating is still ever present. As such, there is a need in the art for a container which reduces or eliminates the above uneven heating problems. The invention provides such a container. These and other advantages of the invention, as well as additional inventive features, will be apparent from the description of the invention provided herein.

### BRIEF SUMMARY OF THE INVENTION

In one aspect, the invention provides a microwavable container for use in a microwave oven. The microwave oven has an interior space and a motor shaft accessible from the interior space of the microwave oven. The motor shaft is configured to rotate a turntable of the microwave oven. An embodiment of the microwavable container includes a container body having an interior space with a removable spatula contained within the interior space. The microwavable container also includes a rod extending through the container body and connected to the spatula. The microwavable container is configured to connect to a motor shaft of a microwave oven such that a rotation of the motor shaft results in a rotation of the spatula.

In embodiments according to this aspect, the container body has shaft which extends upwardly from a bottom of the container body and into the interior space, the rod extending through the shaft. The rod extends through the container body such that an input portion of the rod is accessible from an exterior of the container body. The rod is connected to the spatula and connected to the motor shaft via an adapter pin. A torque transfer arrangement is formed between the adapter pin and the input portion. The torque transfer arrangement includes a plurality of ribs formed on the adapter pin and a plurality of corresponding grooves formed in the input portion for receiving the plurality of ribs, respectively.

In embodiments according to this aspect, the spatula includes at least one fin. The at least one fin extends from a frame structure of the spatula.

In embodiments according to this aspect, the container also includes a plate. The container body is positioned on the plate. The plate is configured to rest upon an interior bottom surface of the microwave oven. The plate has a central opening through which a portion of the microwavable container extends. The plate includes an upwardly extending rim which extends from a bottom portion of the plate. The plate includes a gripping material for contacting the interior bottom surface of the microwave oven.

In another aspect, the invention provides a microwavable container for use in a microwave oven. The microwave oven has an interior space and a motor shaft accessible from the interior space of the microwave oven. The motor shaft is configured to rotate a turntable of the microwave oven. An embodiment of the microwavable container includes a container body having an interior space with a spatula contained within the interior space. The spatula is rotatable within the interior space relative to the container body. A rod extends through the container body such that an input portion of the rod is accessible from an exterior of the container body. The rod is connected to the spatula such that a rotational input provided to the input portion results in a rotation of the spatula within the interior space.

In embodiments according to this aspect, the rotational input is provided by the motor shaft of the microwave oven, and wherein the input portion is connected to the motor shaft via an adapter pin.

In an embodiments according to this aspect, the container also includes a lid. The lid is removably mountable to the container body. The lid may also have a strainer. A spout is formed on the container body. The strainer positioned adjacent the spout when the lid is mounted to the container body. The lid defines a resilient lip and the container body defines a rim. The resilient lip configured to snap over the rim such that the lid connects to the container body via a snap connection.

In yet another aspect, the invention provides a microwavable container for use in a microwave oven. The microwave oven has an interior space and a motor shaft accessible from the interior space of the microwave oven. The motor shaft is configured to rotate a turntable of the microwave oven. An embodiment of the microwavable container includes a container body having an interior space bounded by an interior surface of the container body. The container body has a central shaft extending from a bottom of the container body and into the interior space. The microwavable container also includes a spatula contained within the interior space. The spatula is rotatable within the interior space relative to the container body. A rod extends from an exterior of the container body and through the shaft such that the rod is accessible within the interior space. The rod includes an input portion and rod portion. The spatula removably connected to the rod portion. The spatula extends radially outward from the shaft toward the interior surface of the container body. The spatula is rotatable within the interior space.

In embodiments according to this aspect, the spatula is connected to the rod such that a rotational input provided to the rod results in a rotation of the spatula. The rotational input is provided by the motor shaft of the microwave oven. The rod is connected to the motor shaft via an adapter pin.

In embodiments according to this aspect, the container body includes gripping material configured for contacting a surface upon which the container body rests.

In embodiments according to this aspect, the container also includes a plate configured for resting upon an interior surface of the microwave oven. The plate includes a gripping material for contacting said interior surface. The plate includes a central opening for accessing the motor shaft.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an exemplary embodiment of a microwavable mixing container according to the teachings herein;

FIG. 2 is an exploded view of the container of FIG. 1;

FIG. 3 is another exploded view of the container of FIG. 1;

FIG. 4 is a cross section of the container of FIG. 1;

FIG. 5 is a perspective view of a rod of the container of FIG. 1;

FIG. 6 is an exploded view of the rod of FIG. 5;

FIG. 7 is a perspective view of a spatula of the container of FIG. 1; and

FIG. 8 is a perspective of another embodiment of a spatula.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning now to the drawings, an exemplary embodiment of a microwavable mixing container (also referred to herein as a “container”) is illustrated. As will be understood from the following, a container constructed according to the teachings herein has the advantage of providing a mixing function during microwave cooking. The container has the advantage of utilizing the existing mechanism of the microwave oven ordinarily used for rotating a turntable therein to rotate a spatula of the container. As a result, a very evenly distributed heating of food in the container is achieved. The components of the container are microwave safe, and are easily assembled and disassembled for operation and subsequent cleaning.

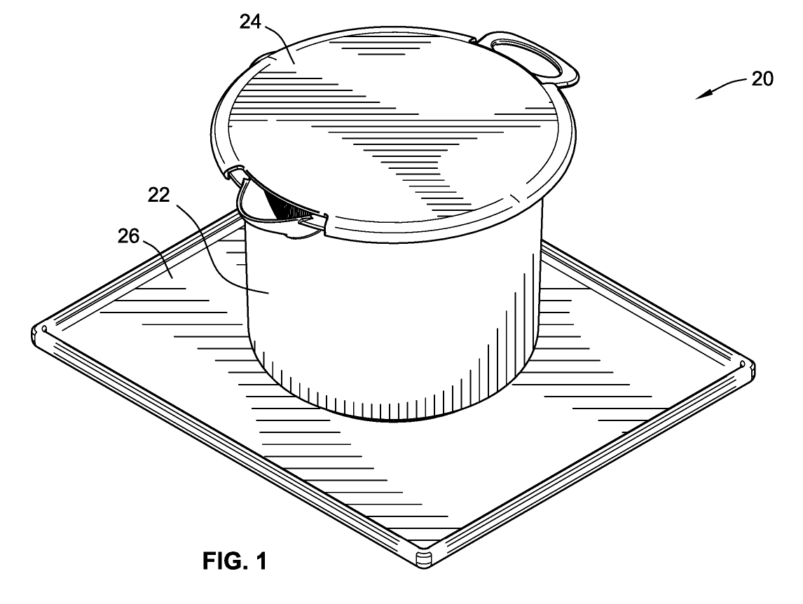

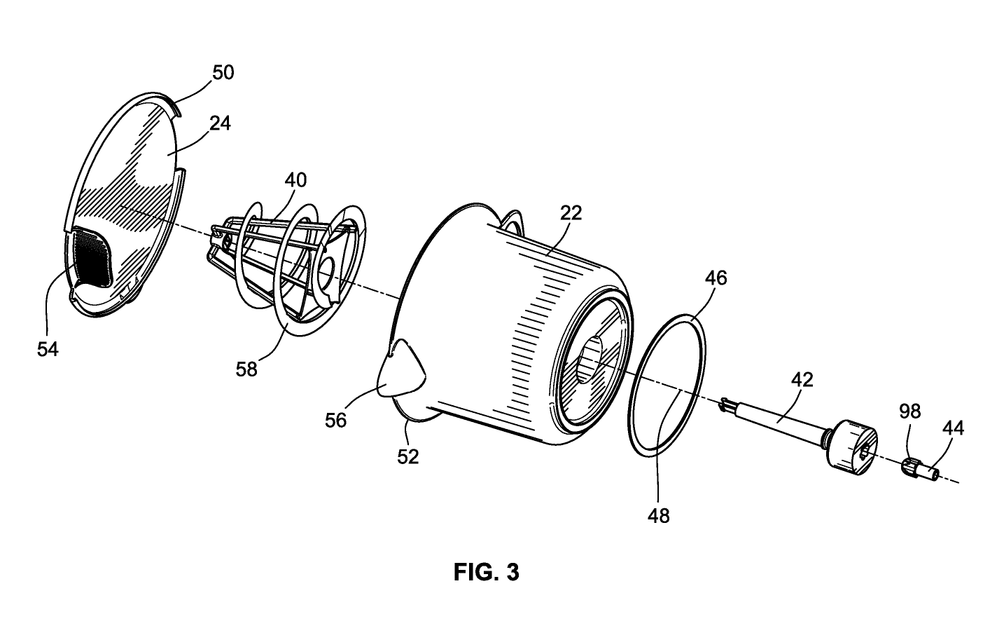

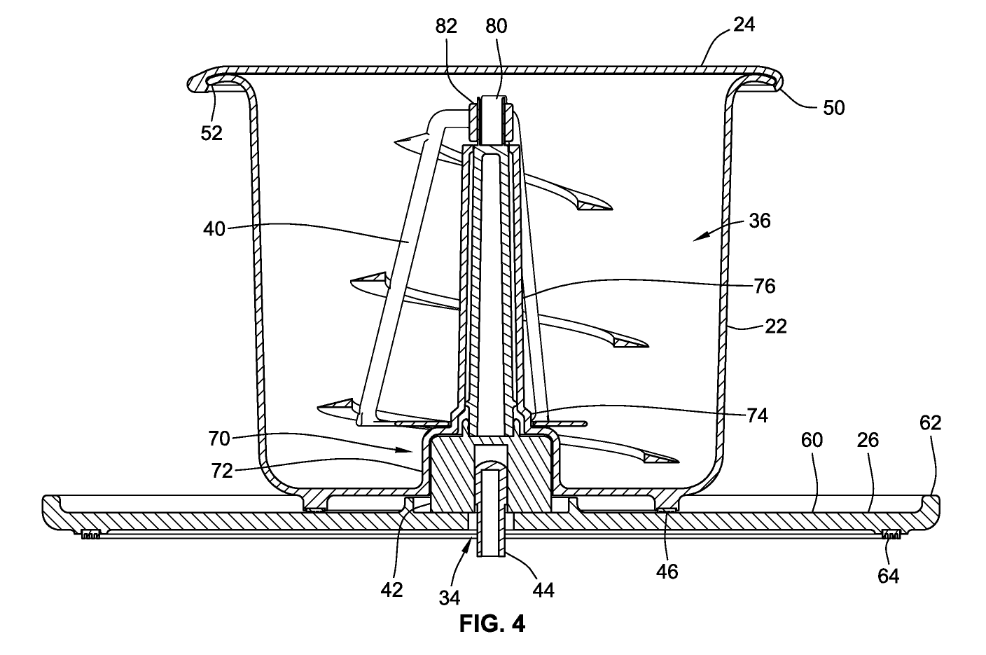

With particular reference now to FIG. 1, a container 20 according to the teachings herein is illustrated. Container 20 includes a bowl referred to herein as a container body 22, which houses a rotatable spatula 40 (see FIG. 3). Spatula 40 is rotatable within an interior space 36 (see FIG. 4) of container body 40. Rotation of spatula 40 provides a mixing function within this interior space 36 such that food therein is mixed during microwave cooking. It will be recognized that container 20 operates quite well with liquids, but is not limited to only liquid form foods. Indeed, any food mixture or product that requires a stirring or mixing operation could be contained within container 20. In other words, container 20 is not limited to any particular type of food.

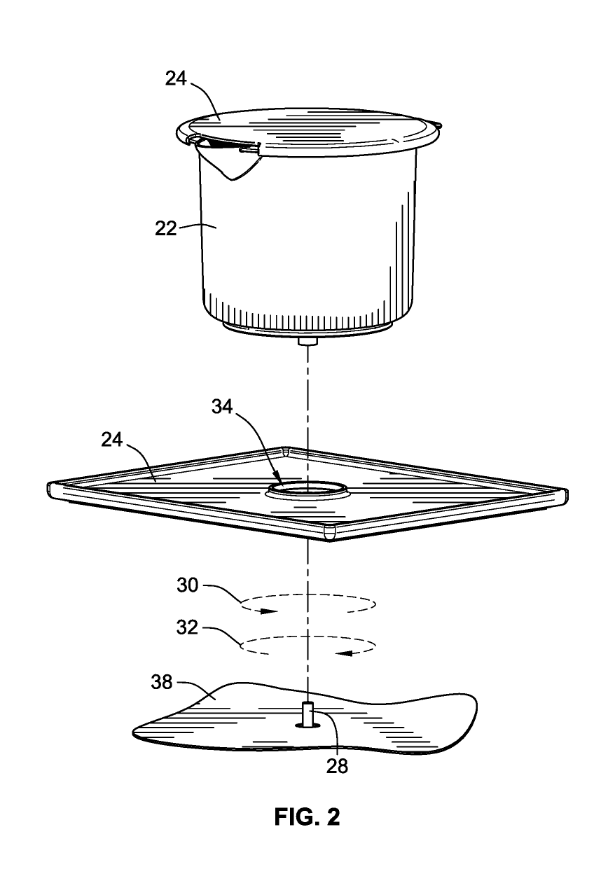

Turning now to FIG. 2, container 20 also includes a plate 26 upon which container body 22 rests. As will be explained below, plate 26 provides a uniform flat surface for container body 22 to rest on. The applicant has found that the interior bottom surface 38 of microwave ovens can vary in geometry from model to model. Certain models have undulations, ridges, or other features on their interior bottom surfaces which can affect the ability to rest container body 22 evenly thereon. Plate 26 advantageously rests on this bottom surface 38 near its outer perimeter, which is reliably flat and level across most models. As such, plate 26 locates on a flat and level surface, and in turn provides a flat and level surface for container body 22.

It is, however, contemplated herein that plate 26 is an optional component. Indeed, container body 22 can readily rest directly on the interior bottom surface of a microwave oven with little to no adaption. As such, the invention is not limited to the inclusion of such a plate, such as plate 26. Also optional is a lid 24 as is shown in FIG. 1. Lid 24 provides all the advantages associated with using a lid during cooking but is not a requirement for the practice of the invention.

Plate 26 includes an opening 34 which provides access by container 20 to an existing motor shaft 28 of the microwave oven. Motor shaft 28 is the shaft that is used to rotate the turntable of the microwave oven. Such turntables and any pieces required for connection to motor shaft 28 may be easily removed. Once removed, container 22 connects to motor shaft 28 as described herein. Rotation of motor shaft 28 in either of directions 30, 32 results in a corresponding rotation of spatula 40 (see FIG. 3). In other words, container 20 utilizes the existing rotation of motor shaft 28 as a rotational input to provide its mixing functionality.

With reference now to FIG. 3, the same illustrates container 20 in an exploded view, with plate 26 omitted for simplicity. Container 20 defines a central longitudinal axis 48 along which the above introduced spatula 40 is arranged along and rotatable about. Spatula may take on any form sufficient to provide a mixing function. In the illustrated embodiment spatula 40 includes a fin 58 as a non-limiting example. Rotation of spatula 40 is achieved via its connection to a rod 42. Rod 42 extends through the bottom of container body 22 and is accessible from an exterior of container body 22. This exterior access of rod 42 allows for a rotational input applied at rod from the exterior of container 20 to create a like rotation of spatula 40 within interior space 36 (see FIG. 4) of container body 22.

Rod 42 may connect to motor shaft 28 (see FIG. 2) of the microwave oven via a pin in the form of adapter pin 44 as shown. Adapter pin 44 can be a separate component as illustrated, or it may be integrally formed with rod 42. In either case, adapter pin 44 may have any features needed to mate with motor shaft 28. As one non-limiting example, adapter pin 44 may have a passage therein which corresponds to the shape of motor shaft 28, such that adapter pin 44 may be slid over motor shaft 28.

Such a shape may be typical of motor shafts in that they commonly have a partially round outer periphery with a flat surface thereon such that they have a “D” shaped cross section. The passage in adapter pin 44 may have a corresponding D-shaped cross section to accommodate such geometry. Of course, any adapter pin 44 may have any features needed to mate with motor shaft 28 such that rotation of motor shaft 28 is transferred to rod 42, and hence spatula 40.

A gripping member 46 may be attached to a bottom of container body 22 such that this gripping member 46 contacts plate 26 (or alternatively bottom interior surface 38 of the microwave oven). Gripping member 46 is a frictional contact enhancer which is used to prevent relative rotation of container body 26 when a rotational input is provided to rod 42. With such a construction, this rotational input is transferred entirely to spatula 40, as opposed to causing container body 22 to rotate relative to plate 26. A similar configuration is used in the context of plate 26, as described below.

Still referring to FIG. 3, lid 24 may also include a resilient lip 50 which may snap over a corresponding rim 52 formed on container body 22 such that lid 24 attaches to container body 22 via a snap-fit connection. Further, lid 24 may also incorporate a strainer 54 which protrudes from a bottom surface of lid. Strainer 54 is located such that it may be positioned adjacent a spout 56 formed on container body 22.

Turning now to FIG. 4, the same illustrates container 20 in cross section. As may be seen in this view, container body 22 rests upon an upper surface 60 of plate 26. A rim 62 extends upwardly from upper surface 60. Rim 62 advantageously contains any spillage from container body 22 onto plate 26 within the boundaries of plate 26. As may also be seen in this view, plate 26 may utilize a gripping material 64 in the region of its contact with interior bottom surface 38 of the microwave oven.

Container body 22 includes a central shaft 70. Shaft 70 includes a hub portion 72, a transition portion extending from the hub portion, and an extension portion 76 extending from the transition portion. Shaft 70 has a bore which permits passage of rod 42 through shaft 70. A top portion 80 of shaft 42 extends above an end of shaft 70 to permit connection to a connection structure 82 of spatula 40 as shown.

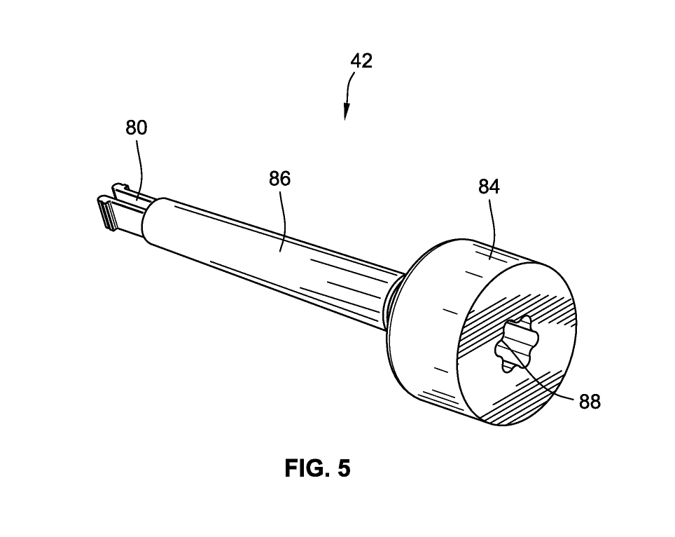

With reference to FIG. 5, rod 42 includes a bottom portion 84 and a rod portion 86 extending from bottom portion 84. Top portion 80 extends from an end of rod portion 86 as shown. Top portion 80 includes structure for connection to connection structure 82 of spatula 40. The structure of top portion 80 and connection structure 82 may take the form of any expedient used to removably connect to items together. This removable connection between spatula 40 and rod 42 allows these components to be readily separated so that spatula 40 may be removed from interior space 36 (see FIG. 4), and rod 42 may be drawn out of shaft 70 from the underside of container body 22. Bottom portion 84 may form part of a torque transfer arrangement between rod 42 and adapter pin 44 (see FIG. 3).

In the illustrated embodiment, this torque transfer arrangement includes a plurality of grooves 88 formed into bottom portion 84 of rod 42, and a plurality of corresponding ribs 98 formed onto adapter pin 44. As a result, when these ribs 98 are received in their corresponding grooves 88, rotation of adapter pin 44 results in a like rotation of rod 42. Other configurations are contemplated by the teachings herein. This torque transfer arrangement may take on any mechanical expedient used to transfer a rotational torque directly between components.

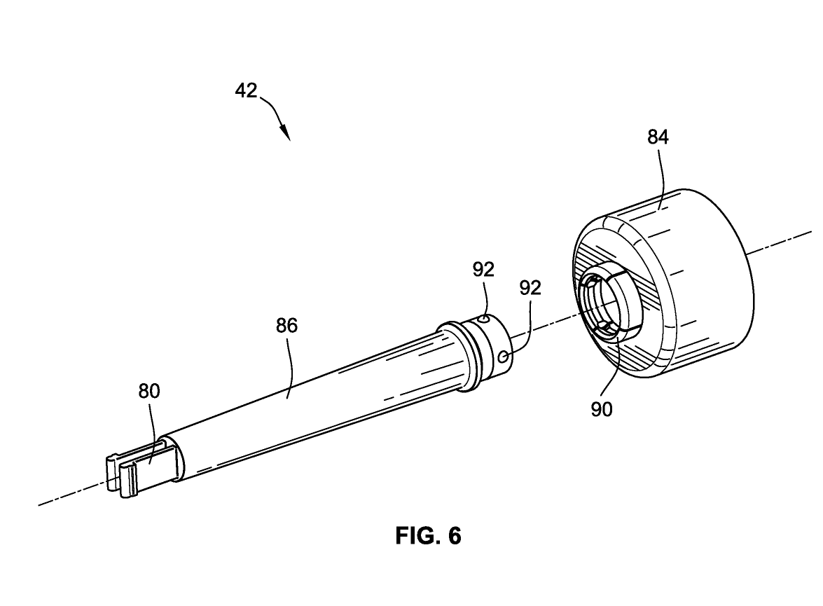

FIG. 6 illustrates rod 42 in an exploded view. Rod portion 86 may be separated from bottom portion 84 as shown. These components may snap together such that they do not rotate relative to one another upon a rotational input at bottom portion 84 by adapter pin 44. To achieve this, rod portion 86 may include a plurality of protrusions 92 which may be received in corresponding hub structure, rod portion 86 is axially located relative to bottom portion 84, but relative rotation between these components is prevented.

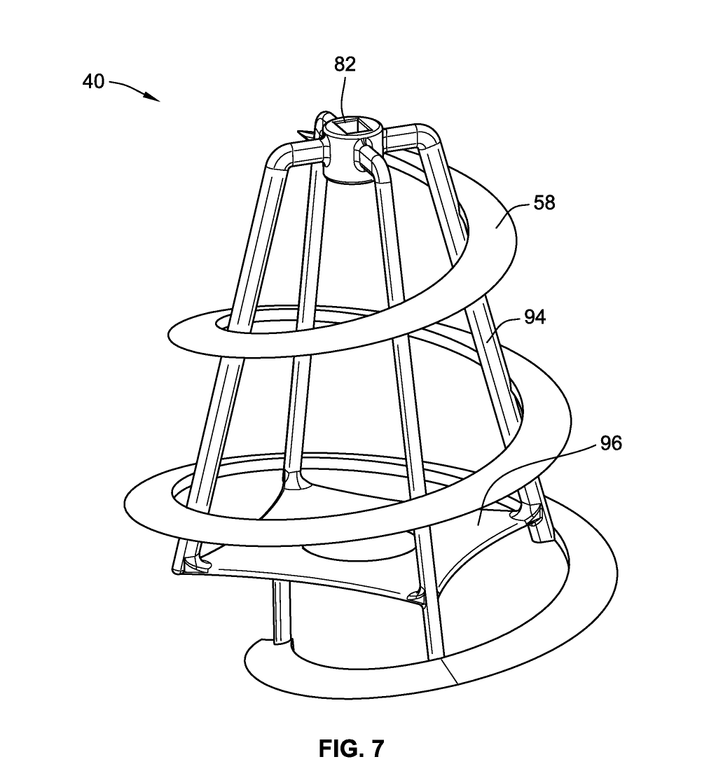

FIG. 7 illustrates a perspective view of spatula 40. Spatula 40 includes a frame 92 which includes connection structure 82 as described above. Fin 58 extends around frame 92 and is used to enhance mixing. Of course, more than one fin could be utilized, and the same need not necessarily follow the helical path as shown.

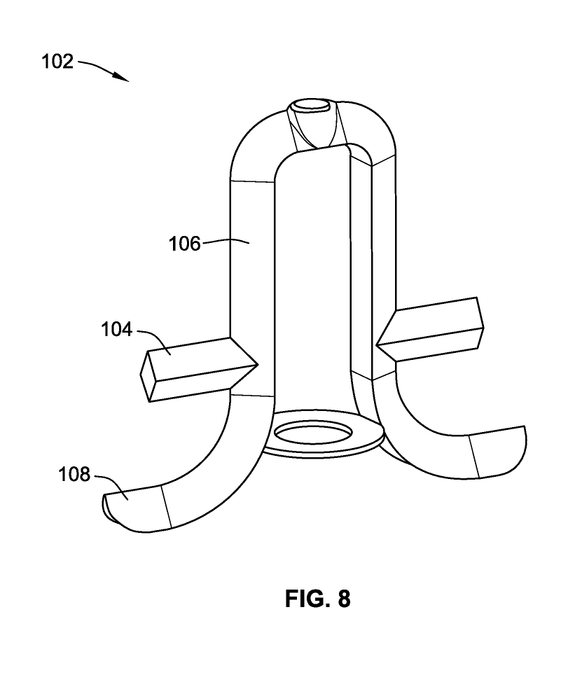

FIG. 8 illustrates an alternative configuration of a spatula 102. Spatula 102 may connect to rod 42 in the same manner as described above. Spatula 102 also includes a frame 106 having a number of fins 104, 108 integrated therein.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A microwavable container for use in a microwave oven, the microwave oven having an interior space and a motor shaft accessible from the interior space of the microwave oven, the motor shaft configured to rotate a turntable of the microwave oven, the microwavable container comprising:
a container body having an interior space;
a removable spatula contained within the interior space;
a rod extending through the container body and connected to the spatula;
wherein the microwavable container is configured to connect to a motor shaft of a microwave oven such that a rotation of the motor shaft results in a rotation of the spatula.

2. The microwavable container of claim 1, wherein the container body has shaft which extends upwardly from a bottom of the container body and into the interior space, the rod extending through the shaft.

3. The microwavable container of claim 2, wherein the rod extends through the container body such that an input portion of the rod is accessible from an exterior of the container body, the rod connected to the spatula and connected to the motor shaft via an adapter pin.

4. The microwavable container of claim 3, further comprising a torque transfer arrangement formed between the adapter pin and the input portion.

5. The microwavable container of claim 4, wherein the torque transfer arrangement includes a plurality of ribs formed on the adapter pin and a plurality of corresponding grooves formed in the input portion for receiving the plurality of ribs, respectively.

7. The microwavable container of claim 1, wherein the spatula includes at least one fin.

8. The microwavable container of claim 7, wherein the at least one fin extends outwardly from a frame structure of the spatula.

9. The microwavable container of claim 1, further comprising a plate, the container body positioned on the plate, the plate configured to rest upon an interior bottom surface of the microwave oven, the plate having a central opening through which a portion of the microwavable container extends.

10. The microwavable container claim 9, wherein the plate includes an upwardly extending rim which extends from a bottom portion of the plate, and wherein the plate includes a gripping material for contacting the interior bottom surface of the microwave oven.

11. A microwavable container for use in a microwave oven, the microwave oven having an interior space and a motor shaft accessible from the interior space of the microwave oven, the motor shaft configured to rotate a turntable of the microwave oven, the microwavable container comprising:
a container body having an interior space;
a spatula contained within the interior space, the spatula rotatable within the interior space relative to the container body;
a rod extending through the container body such that an input portion of the rod is accessible from an exterior of the container body, the rod connected to the spatula such that a rotational input provided to the input portion results in a rotation of the spatula within the interior space.

12. The microwavable container of claim 11, wherein the rotational input is provided by the motor shaft of the microwave oven, and wherein the input portion is connected to the motor shaft via an adapter pin.

13. The microwavable container of claim 11, further comprising a lid, the lid removably mountable to the container body and having a strainer, and wherein a spout is formed on the container body, the strainer positioned adjacent the spout when the lid is mounted to the container body.

14. The microwavable container of claim 13, wherein the lid defines a resilient lip and the container body defines a rim, the resilient lip configured to snap over the rim such that the lid connects to the container body via a snap connection.

15. A microwavable container for use in a microwave oven, the microwave oven having an interior space and a motor shaft accessible from the interior space of the microwave oven, the motor shaft configured to rotate a turntable of the microwave oven, the microwavable container comprising:
a container body having an interior space bounded by an interior surface of the container body, the container body having a central shaft extending from a bottom of the container body and into the interior space;
a spatula contained within the interior space, the spatula rotatable within the interior space relative to the container body;
a rod extending from an exterior of the container body and through the shaft such that the rod is accessible within the interior space, the rod including an input portion and rod portion, the spatula removably connected to the rod portion;
wherein the spatula extends radially outward from the shaft toward the interior surface of the container body, the spatula rotatable within the interior space.

16. The microwavable container of claim 15, wherein the spatula is connected to the rod such that a rotational input provided to the rod results in a rotation of the spatula.

17. The microwavable container of claim 16, wherein the rotational input is provided by the motor shaft of the microwave oven, wherein the rod is connected to the motor shaft via an adapter pin.

18. The microwavable container of claim 15, wherein the container body includes gripping material configured for contacting a surface upon which the container body rests.

19. The microwavable container of claim 15, further comprising a plate configured for resting upon an interior surface of the microwave oven, the plate including a gripping material for contacting said interior surface.

20. The microwavable container 19, wherein the plate includes a central opening for accessing the motor shaft.
